(19) United States
(12) Patent Application Publication
(10) Pub. No.: US 2013/0282707 A1
(43) Pub. Date: Oct. 24, 2013

(54) TWO-STEP COMBINER FOR SEARCH RESULT SCORES

(71) Applicant: DISCOVERY ENGINE CORPORATION, San Francisco, CA (US)

(72) Inventors: Oscar B. Stiffelman, San Francisco, CA (US); Noah S. Caplan, Berkeley, CA (US)

(73) Assignee: Discovery Engine Corporation, San Francisco, CA (US)

(21) Appl. No.: 13/868,578

(22) Filed: Apr. 23, 2013

Related U.S. Application Data
(60) Provisional application No. 61/637,473, filed on Apr. 24, 2012.

(51) Int. Cl. G06F 17/30

(52) U.S. Cl. CPC G06F 17/30979
USPC 707/723

(57) ABSTRACT

A method for a two-step combiner for scoring search results is disclosed. The method comprises: calculating a fast score for a document based on a quality score of the document and a plurality of topicality scores; comparing the fast score for the document to a plurality of previously scored documents in a priority queue; calculating a final score for the document only when the fast score exceeds a lowest scored document in the priority queue; and adding the document to the priority queue when the final score exceeds a lowest final score on the priority queue.

### CROSS-REFERENCE TO RELATED APPLICATIONS

This application claims priority to U.S. Provisional Patent Application Ser. No. 61/637,473 filed Apr. 24, 2012, which is incorporated by reference herein in its entirety.

### BACKGROUND OF THE INVENTION

1. Field of the Invention

Embodiments of the present invention generally relate to document retrieval and, more particularly, to a process for scoring search results.

2. Description of the Related Art

Search engines look through billions of documents on the web in order to return the most relevant results in response to a user query. In order to determine which documents are most relevant, complex algorithms are used to score each document so that those documents with the highest scores may be returned to a user. A challenge of search engines is to score the billions of documents in such a way that the most relevant documents are not excluded and to complete the task in a matter of milliseconds.

In order to accomplish this monumental task of document retrieval, the process is broken down into two distinct phases: an off-line phase and an on-line phase. The off-line phase comprises retrieving and indexing the documents from the internet. The on-line processing phase comprises scoring the documents based on a user query and, based on those scores, selecting the most relevant documents to be displayed to the user.

One known technique for performing the off-line phase is disclosed in commonly assigned U.S. Patent Application Number 2011/0022591, and shown in method 100 of FIG. 1. The method 100 comprises acquiring and indexing the documents that are to be searched. The method 100 begins at step 102 and proceeds to step 104. At step 104, documents are acquired from the internet. This step may involve sending a large number of Hyper-text Transfer Protocol (HTTP) requests to retrieve Hyper-text Markup Language (HTML) documents from the World Wide Web. Other data protocols, formats, and sources may also be used to acquire documents. The method 100 proceeds to step 106.

At step 106, the links for each document are inverted. Each document comes with a link representing a reference from a source document to its destination document. For example, most HTML documents on the web contain “anchor” tags that explicitly reference other documents by Uniform Resource Locator (URL). During the link inversion step, links are collected by destination document instead of source. After link inversion is completed, each acquired document contains a list of all other documents that reference it. The text from these incoming links (“anchor-text”) provides an important source of annotation for a document.

The method 100 proceeds to step 108. At step 108, each document retrieved is assigned a quality score based on the quality of the source of the document. Quality is a per document measurement. The quality score of a document may be based on what domain the document is retrieved from, based on the text of the document, based on links that point to the document, based on the Internet Protocol (IP) address, and the like. Some IP addresses are considered to be of a higher quality than others because they are more expensive to acquire than others and therefore are likely to contain higher quality information. For example, a document from WIKIPEDIA® may have a high quality score. A document from a website with an extension of .gov may have a high quality score. A video on YOUTUBE® may not have a high quality document, but the YOUTUBE® homepage may be a high quality document. Any number of features may be used to determine a quality score. The method 100 proceeds to step 110.

At step 110, unigram (one-word) terms and proximity terms, are enumerated from the document title, the on-page text, and the anchor-text of each document. These terms represent the most important aspects of the document. Proximity terms are generated using the following procedure; however, other procedures may be used. A proximity window of size N words is used to traverse a given text string comprised of M words. The proximity window starts at the first word in the text string, extending N words to the right. This window is shifted right M-N times. At each window position, there will be N words (or fewer) in the proximity window. Proximity terms are produced by enumerating the power set of all words in the proximity window at each window position. Note that proximity terms are not limited to contiguous words or phrases. Proximity terms may be filtered based on criteria such as frequency of occurrence. Proximity terms may be comprised of 2 or more words.

Consider the example of the text string hillary rodham clinton. This text is decomposed into the unigram terms: hillary, rodham, and clinton; and the proximity terms: hillary rodham, rodham clinton, and hillary clinton.

A wide variety of techniques may be employed for selecting or filtering terms. The method 100 proceeds to step 112.

At step 112, topicality scores are calculated for each unigram term and proximity term. A wide variety of functions can be used for calculating topicality scores. The function is employed to pre-compute a single numerical score for each term generated in step 110. The topicality score represents how “on topic” a document is based on the term. The method 100 proceeds to step 114.

At step 114, an index is built from the terms generated in step 110 and their topicality scores. Each entry in the index is called a “posting list” and comprises a term (unigram or proximity), and a list of all documents containing that term, in addition to metadata. Metadata consists of the quality score of a document and may also include other document features, such as font size and color. Once all documents have been added to the index, the off-line phase is complete. The method 100 proceeds to step 114 and ends.

In the on-line processing phase, there are a variety of algorithms which may be employed to determine which of the possibly million or more documents that may be returned as being relevant to the user's search query, are returned as being most relevant. Some algorithms calculate a score representing a document's relevance based on the frequency of each query term in the document, while others are based on the frequency the document is accessed on the Internet. Regardless of which algorithm is used, this final step must be performed using the fastest means possible in a way that preserves relevant documents with minimal delay. It would be beneficial to reduce the number of documents on which expensive processing time is spent without sacrificing accuracy in the document retrieval process.

Therefore, there is a need in the art for an improved technique for scoring search results.

### SUMMARY OF THE INVENTION

A method for a two-step combiner for search result scores substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout

### BRIEF DESCRIPTION OF THE DRAWINGS

So that the manner in which the above recited features of the present invention can be understood in detail, a more particular description of the invention, briefly summarized above and described in detail below, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram for acquiring and indexing documents;

FIG. 2 is a block diagram of a system for a two-step combiner for search term results, according to some embodiments of the invention; and

FIG. 3 is a flow diagram for determining search results, according to one or more embodiments of the invention.

### DETAILED DESCRIPTION

Embodiments of the present invention minimize latency after a query has been issued by a user and before results have been returned to the user. Embodiments of the present invention reduce processing time by computing a fast score for a document and then only computing a document's final score if the fast score indicates the document is more likely to be a relevant search result to a user query. Because the final score is only calculated for documents having a fast score that is higher than a final score of other relevant documents, expensive processing time is not wasted calculating final scores for documents that are less likely to be relevant.

The present invention is initiated when a user submits a query to a search engine. According to some embodiments, the invention creates a priority queue of arbitrary length, k, containing the most relevant documents with respect to the user query as well as a final score for each document in the priority queue. As described previously regarding the off-line mode, the documents have been downloaded into memory and an index has been created with topicality scores for the indexed unigram and proximity terms.

The search engine parses the query into unigram (one-word) terms. As discussed in the previous example, the query “Hillary Rodham Clinton” would be parsed into unigram terms, namely “Hillary”, “Rodham” and “Clinton”. Each term is looked up in the index and a list of all documents containing each term is retrieved. In this example, three lists would be retrieved from the index; one for each term in the query. A logical intersection is performed which removes any documents that do not contain all of the unigram terms in the query. The remaining documents may be referred to as “survivors” because they survived the logical intersection. In the present example, the survivors contain all three terms “hillary”, “rodham”, and “clinton” somewhere in the document. As a non-limiting example, it is noted that the number of survivor documents may be 1,000,000 or more.

The query terms are then reconstructed, meaning the unigram terms are reconnected into two-word terms, called proximity terms. In this example the proximity terms are “hillary rodham”, “hillary clinton” and “rodham clinton”.

When each document was downloaded during the offline phase, it was given a quality score based, for example, on the source of the document. For example, a publication from a renowned research facility would have a higher quality scored than a publication from a high school science club. The quality score is retrieved from a search information file. In addition, the topicality scores are retrieved from the search information file for all of the unigram and proximity terms. In order to reduce the number of survivor documents to those that are most relevant, a priority queue of arbitrary length, k, is created containing the most relevant documents with respect to the user query, as well as a final score for each of the survivor document in the priority queue. As a non-limiting example, it is noted that k may be 10. A fast score is calculated for each survivor document based on the quality score of the document source and the topicality scores of the unigram and proximity terms. The fast score is then compared to the final scores of the documents in the priority queue. If the fast score is greater than the k^{th} worst final score in the priority queue, then a final score is calculated for that survivor document.

Only after that survivor document receives a fast score high enough to exceed the final score of a document currently in the priority queue, are expensive processing cycles used to compute a “final” score for that survivor document. This saves processing cycles by getting rid of survivor documents that have little relevancy to the search query before the time-expensive processing takes place. The two-step combiner saves valuable processing time by eliminating survivor documents that are determined to be unable to have a final score that is sufficiently high to be included in the priority queue.

As a non-limiting example, in one embodiment, the final score is calculated using a generalized mean. In one embodiment, the final score is calculated using a harmonic mean. In another embodiment, the final score is calculated using a geometric mean. In either case, the calculated final score must be less than or equal to the calculated fast score. In accordance with some embodiments of the invention, if this “final” score is higher than the k^{th} worst final score on the priority queue, the document is placed in the priority queue. The method then ensures the priority queue does not exceed a maximum allowable length and, if it does, the method removes the lowest scored document on the queue in order to return the priority queue to its maximum allowable length.

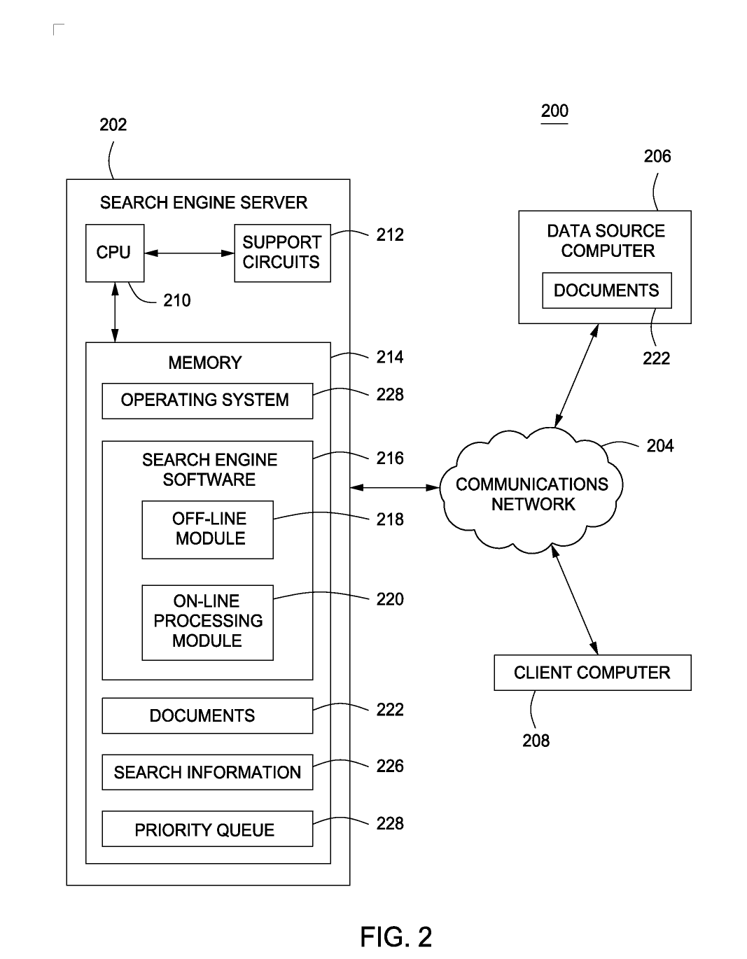

FIG. 2 depicts a computer system 200 comprising a search engine server 202, a communications network 204, a data source computer 206 and at least one client computer 208. The system 200 enables a client computer 208 to interact with the search engine server 202 via the network 204, identify data (documents 222) at one or more data source computers 206 and display and/or retrieve the data from the data source computers 206.

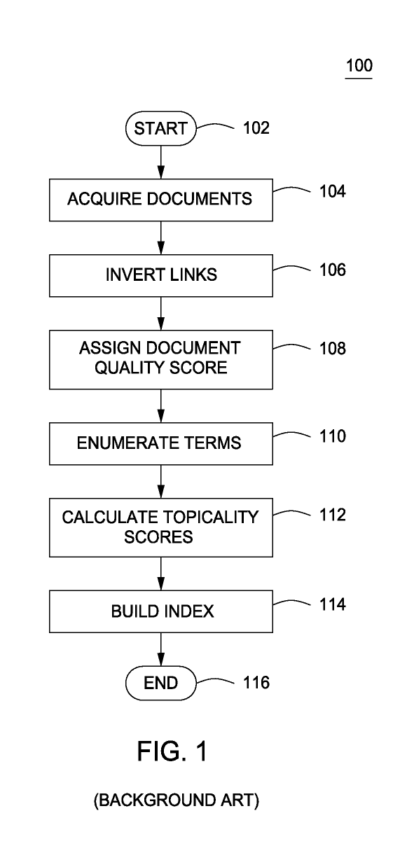

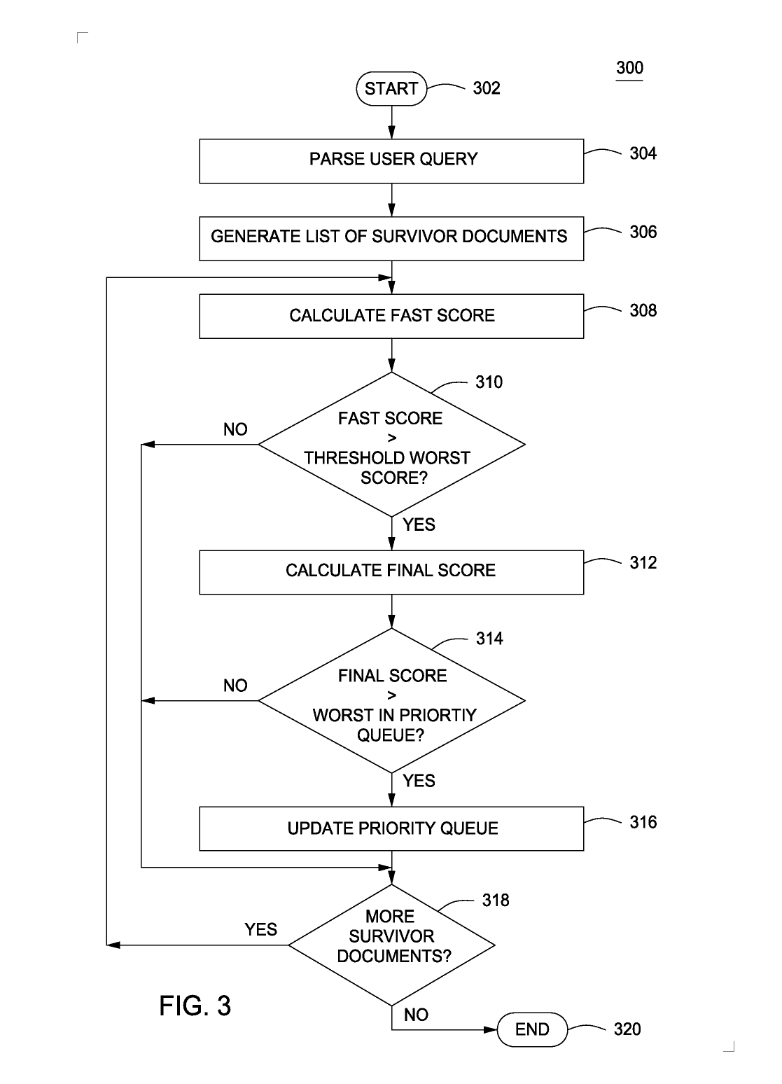

The search engine server 202 comprises a Central Processing Unit (CPU) 210, support circuits 212 and memory 214. The CPU 210 comprises one or more generally available microprocessors used to provide functionality to a computer server 202. The support circuits 212 support the operation of the CPU 210. The support circuits 212 are well known circuits comprising, for example, communications circuits, input/output devices, cache, power supplies, clock circuits, and the like. The memory 214 comprises various forms of solid state, magnetic and optical memory used by a computer to store information and programs including but not limited to random access memory, read only memory, disk drives, optical drives and the like. The memory 214 comprises an operating system 228, search engine software 216, documents 222, search information 226, and a priority queue. The operating system 228 may be one of many commercially available operating systems such as LINUX, UNIX, OSX, WINDOWS and the like. The documents 222 are typically stored in a database. The search information 226 comprises posting lists, indices and other information created using method 100 in FIG. 1 and used by the search engine software 216 to perform searching as described below with respect to FIG. 3. The search engine software 216 comprises an off-line module 218 and an on-line processing module 220. In operation, the search engine server 202 acquires documents 222 from the data source computers 206, creates indices and other information (search information 226) related to the documents 222 using the off-line module 218 of the search engine 216. The on-line processing module 220 is relevant to this invention, as next described.

The client computer 208 using well-known browser technology sends a query to the search engine server 202. The search engine server 202 uses the on-line processing module 220 to process a user query and create a priority queue 228 of the most relevant documents to return for display to the client computer 208.

FIG. 3 is a method 300 for determining the most relevant search results using a two-step combiner, according to one or more embodiments of the invention. The method 300 builds a priority queue containing a list of the top k documents determined to be relevant to a user query. The method 300 starts at step 302 and proceeds to step 304.

At step 304, the method 300 parses a user query. The user query is broken into relevant terms. For example, a query may be “land before time child actress”. In some embodiments, the method 300 may identify the bigrams “land before” and “before time” as relevant terms. Further, the method 300 may identify the bigram “child actress” as a relevant term. The method 300 may determine that the bigram “time child” is not a relevant term. In some embodiments, the method 300 may proceed with the bigrams “land before”, “before time”, “time child”, and “child actress” divided into two subsets. In this case the method 300 places the bigrams “land before”, “before time”, and “child actress” into the subset of relevant terms and places the bigram “time child” into the subset of terms that have little or no relevance. Additional query processing, such as removal of very common terms (e.g., “a”, “the”, “an”, and the like), may also be performed at this step. However, in some embodiments, a stop word in combination with other terms may be relevant. For example, a query may be “who is in the who”. The term “who”, despite appearing twice, has little to no relevance. However, the bigram “the who” is extremely relevant, in that it is the name of a famous musical group. As such, in some embodiments, a query made up of stop words may be considered relevant and a bigram that begins with a stop word may be considered relevant. For example, in a query of “Bob the Builder”, “Bob the” may not be considered relevant, but “the Builder” may be considered relevant. In general, a wide variety of algorithms and techniques well know to those of ordinary skill in the art may be employed to parse the query. Parsing may results in unigrams, bigrams, n-grams or proximity terms that are identified as relevant terms. The method 300 proceeds to step 306.

At step 306, the method 300 generates a list of survivor documents based on the user query. The method 300 uses the index in the search information file to acquire a list of all documents that contain each relevant term. Once a list of all of the documents is retrieved for each relevant term, an intersection is performed to filter out any documents that do not contain all relevant search terms. The documents that contain all of the relevant terms are called “survivor documents” as they have survived the intersection. Survivor documents are all documents that contain every relevant query term. As a non-limiting example, there may be 1,000,000 or more survivor documents. The method 300 proceeds to step 308.

At step 308, the method 300 performs the first step of the two-step combiner. A fast score is calculated for a survivor document. The method 300 accesses a quality score for the document. The quality score was stored when the document was downloaded and therefore quickly defines the quality of the source of the document. In some embodiments, the method 300 applies a fast score algorithm to calculate the fast score, defined as:

S_{f}=q*(Σtᵢ) Equation 1

where:
S_{f} is the fast score for the document,
q is the quality score for the document, and
tᵢ is the topicality score for each relevant term reconstructed from the user query.

In some embodiments, the method 300 applies a fast score algorithm to calculate the fast score, defined as:

S_{f}=q+(Σtᵢ) Equation 2

where:
S_{f} is the fast score for the document,
q is the quality score for the document, and
tᵢ is the topicality score for each relevant term reconstructed from the user query.

The fast score is considered “fast” because it uses primarily inexpensive processor operations (namely, addition). The method 300 proceeds to step 310.

At step 310, the method 300 determines whether the fast score for the document is greater than the worst of already calculated final scores of a predetermined limited number of survivor documents that are in the priority queue. The priority queue contains up to k most relevant of the survivor documents, where k is an arbitrary number, but for purposes of example, may be 10 (while, as noted above, the number of survivor documents, for purposes of example, may be 1,000,000 or more). The priority queue is organized with the lowest scoring entry always at the “front” of the queue so that the worst document of the top k documents can immediately be compared to a current survivor document. In one embodiment, the priority queue is implemented using a heap data structure, although those skilled in the art can appreciate various structures that can be used for the priority queue. Initially, the first k documents automatically make it onto the priority queue because there is no k^{th} worst document to compare it to. The k^{th} document is the worst (lowest) ranked document in the queue of k documents.

Once the priority queue is full and contains k documents, as each successive survivor document is fast scored, if its fast score is above the final score of the k^{th} worst ranked document in the priority queue, the document continues on through the scoring process. If the document's fast score is below the k^{th} worst ranked document in the priority queue, the document is excluded. As such, at step 310, if the method 300 determines the document's fast score is below the k^{th} worst ranked document in the priority queue, the method 300 proceeds to step 318. However, if at step 310, the method 300 determines that the fast score for the document is greater than the kth worst final score in the priority queue, the method 300 proceeds to step 312.

At step 312, the method 300 performs the second step of the two-step combiner. The method 300 calculates a final score for the document. Because the final score uses expensive processing time, this step is only reached when the document's fast score is high enough to identify it as a possible relevant document as determined by comparison with the scores of the documents already in the priority queue. In one embodiment, the final score is calculated using the quality score of the document and a linear combination of generalized means of distinct subsets of topicality scores such that for all generalized means, the exponent does not exceed one (1) and the coefficients in the linear combination never exceed one (1). The final score is a more accurate score for the relevance of a document. A document's final score will always be less than or equal to the document's fast score.

In some embodiments, the final score, when calculated in conjunction with the calculated fast score in Equation 1 above, may be calculated as follows:

$${S}_{r} = q * [ \sum {C}_{j} * {[ \frac{1}{{N}_{j }} {\sum }_{i}^{{N}_{j}} {t}_{{j}_{i}}^{{P}_{j}} ]}^{\frac{1}{{P}_{j}}} ] \qquad Equation 3$$

where:
Sᵣ is the final score for the document,
q is the quality score for the document,
Cⱼ is the coefficient of topicality subset j,
Nⱼ is the number of topicality scores in subset j,
tⱼ_{ᵢ} is the ith topicality score of the jth subset of topicality scores,
Pⱼ is the exponent of the generalized mean of the jth subset of topicality scores,

where the subsets are distinct and the following requirements are met:

$$\begin{matrix}{C}_{j} \leq 1 & ( 1 ) \\ 0 \leq {t}_{ji} & ( 2 ) \\ if {P}_{j} > 1 , then {C}_{j} \leq {( \frac{1}{{N}_{j}} )}^{\frac{1}{{P}_{j}}} & ( 3 )\end{matrix}$$

In some embodiments, the final score, when calculated in conjunction with the calculated fast score in Equation 2 above, may be calculated as follows:

$${S}_{r} = q + [ \sum {C}_{j} * {[ \frac{1}{{N}_{j}} {\sum }_{i}^{{N}_{j}} {t}_{{j}_{i}}^{{P}_{j}} ]}^{\frac{1}{{P}_{j}}} ] \qquad Equation 4$$

where:
Sᵣ is the final score for the document,
q is the quality score for the document,
Cⱼ is the coefficient of topicality subset j,
Nⱼ is the number of topicality scores in subset j,
tⱼ_{ᵢ} is the ith topicality score of the jth subset of topicality scores,
Pⱼ is the exponent of the generalized mean of the jth subset of topicality scores,

where the subsets are distinct and the following requirements are met:

$$\begin{matrix}{C}_{j} \leq 1 & ( 1 ) \\ 0 \leq {t}_{{j}_{i}} & ( 2 ) \\ if {P}_{j} > 1 , then {C}_{j} \leq {( \frac{1}{{N}_{j}} )}^{\frac{1}{{P}_{j}}} & ( 3 )\end{matrix}$$

As a result, the final score is always less than or equal to the fast score for a document.

In one example for the final score, if the generalized mean is of all of the topicality scores, there is one generalized mean, one subset of topicality scores (all of them) and the coefficient of the linear combination is 1.

In another example for calculating the final score, if the generalized mean of topicality scores is for relevant terms, there are two distinct subsets of topicality scores, a relevant subset and a non-relevant subset. The linear combination coefficient for the relevant subset is 1 and the linear combination coefficient for the non-relevant subset is 0.

In yet another example, the two distinct subsets may be topicality scores of unigrams and topicality scores of bigrams. For all p values less than 1.0 (i.e., the exponent of the generalized mean), the two-step combiner is guaranteed to not discard any document that belongs in the final set. The method 300 proceeds to step 314. At step 314, the method 300 determines whether the final score for the document is greater than the worst (lowest) final score in the priority queue. If the final score is less than the worst final score in the priority queue, then the document is excluded. As such, the method 300 proceeds to step 318. If the final score is greater than the worst final score in the priority queue, the method 300 proceeds to step 316.

At step 316, the priority queue is updated. Because the final score of the document is greater than the worst final score in the priority queue, the document is added to the priority queue. However, the priority queue may only contain a pre-defined number of documents, for example, k. When the new document is added to the queue, if that document causes the queue to exceed its maximum allowable length, the method 300 removes the document with the lowest final score, i.e., the document determined to be least relevant. The method 300 proceeds to step 318.

At step 318, the method 300 determines whether there are more survivor documents to process. If there are more survivor documents to process, the method 300 proceeds to step 308 and iterates until all survivor documents have been processed. If at step 318, there are no more survivor documents to be processed, the method 300 proceeds to step 320 and ends.

In another embodiment, a method receives a user query and in response, calculates a fast score for each document and stores them in, for example, descending order according to the calculated fast scores. Starting with the document with the highest fast score, a final score is calculated. At some point, the final scores that are computed are higher than the fast scores for the remaining documents. When this point is reached, the top documents are identified. For example, if there are fifty (50) documents on the Internet and the documents receive quality scores as follows:

TABLE 1

| Document Number | Fast Score | Final Score |
|---|---|---|
| 1 | 50 | 48 |
| 2 | 49 | 47 |
| 3 | 48 | 46 |
| 4 | 47 | 45 |
| 5 | 46 | 44 |
| 6 | 45 | 43 |
| 7 | 44 | 42 |
| 8 | 43 | 41 |
| 9 | 42 | 40 |
| 10 | 41 | 39 |
| 11 | 40 | 38 |
| 12 | 39 | 37 |
| 13 | 38 | |
| etc. | | |

Suppose the top ten (10) documents are requested. The method calculates the fast scores for each document and the documents are stored in descending order according to their fast score. Then, beginning with the document with the highest fast score, a final score is calculated. If the final scores are as listed above, when the final score is calculated for the 12^{th} document, it can be noted that the document received a final score of 37 and had a fast score of 39, which is the final score of the 10^{th} best document. All of the remaining fast scores are lower than 39 and all of the other final scores are lower than 39. Therefore, the top ten (10) documents are determined and the final score, which uses expensive processing time only had to be calculated twelve (12) times.

While the foregoing is directed to embodiments of the present invention, other and further embodiments of the invention may be devised without departing from the basic scope thereof, and the scope thereof is determined by the claims that follow.

1. A computer-implemented method for a two-step combiner for scoring search results comprising:
calculating a fast score for a document based on a quality score of the document and a plurality of topicality scores;
comparing the fast score for the document to final scores of a plurality of previously scored documents in a priority queue;
calculating a final score for the document only when the fast score exceeds the final score of a lowest scored document in the priority queue; and
adding the document to the priority queue when the final score exceeds the final score of a lowest final score on the priority queue.

2. The method of claim 1, wherein the quality score is based on the quality of the source of the document.

3. The method of claim 1, wherein the plurality of topicality scores are pre-computed scored defining a relevance of the document to each of a plurality of search terms.

4. The method of claim 1, wherein the priority queue is of a predetermined size k and contains a list of documents having the k highest final scores.

5. The method of claim 1, wherein the fast score is computed by multiplying the quality score of the document times the sum of the plurality of topicality scores.

6. The method of claim 1, wherein the final score is computed by multiplying the quality score of the document times a linear combination of generalized means of distinct subsets of topicality scores such that for all generalized means.

7. The method of claim 6, wherein an exponent for the generalized mean does not exceed 1.

8. The method of claim 6, wherein coefficients in the linear combination do not exceed 1.

9. The method of claim 1, wherein the fast score is faster to computer than the final score.

10. The method of claim 1, wherein the fast score is always greater than or equal to the final score.

11. The method of claim 1, wherein calculating the final score comprises computing using a combiner based on the plurality of topicality scores and a number of documents in the priority queue, wherein the fast score is guaranteed to be larger than or equal to the final score.

12. A non-transient computer readable storage medium for storing computer instructions that, when executed by at least one processor cause the at least one processor to perform a method for a two-step combiner for scoring search results comprising:
calculating a fast score for a document based on a quality score of the document and a plurality of topicality scores;
comparing the fast score for the document to final scores of a plurality of previously scored documents in a priority queue;
calculating a final score for the document only when the fast score exceeds the final score of a lowest scored document in the priority queue; and
adding the document to the priority queue when the final score exceeds the final score of a lowest final score on the priority queue.

13. The computer readable medium of claim 12, wherein the quality score is based on the quality of the source of the document.

14. The computer readable medium of claim 12, wherein the plurality of topicality scores are pre-computed scored defining a relevance of the document to each of a plurality of search terms.

15. The computer readable medium of claim 12, wherein the priority queue is of a predetermined size k and contains a list of documents having the k highest final scores.

16. The computer readable medium of claim 12, wherein the fast score is computed by multiplying the quality score of the document times the sum of the plurality of topicality scores.

17. The computer readable medium of claim 12, wherein the final score is computed by multiplying the quality score of the document times a linear combination of generalized means of distinct subsets of topicality scores such that for all generalized means.

18. The computer readable medium of claim 17, wherein an exponent for the generalized mean does not exceed 1, and wherein coefficients in the linear combination do not exceed 1.

19. The computer readable medium of claim 12, wherein the fast score is faster to computer than the final score and the fast score is always greater than or equal to the final score.

20. The computer readable medium of claim 12, wherein calculating the final score comprises computing using a combiner based on the plurality of topicality scores and a number of documents in the priority queue, wherein the fast score is guaranteed to be larger than or equal to the final score.
